(19) United States
(12) Patent Application Publication
(10) Pub. No.: US 2026/0347627 A1
(43) Pub. Date: Nov. 5, 2026

(54) Formulation For An Insulation System, Use Of Same And Moulded Body

(71) Applicant: Siemens Mobility GmbH, München (DE)

(72) Inventors: Marek Maleika, Fürth (DE); Florian Schemmel, Nürnberg (DE); Niels Müller, Georgensgmünd (DE); Steffen Lang, Hallerndorf (DE)

(73) Assignee: Siemens Mobility GmbH, München (DE)

(21) Appl. No.: 19/121,490

(22) PCT Filed: Oct. 18, 2023
(86) PCT No.: PCT/EP2023/078988

§ 371 Date: Apr. 16, 2025

(30) Foreign Application Priority Data
Oct. 24, 2022 (EP) 22203336.7
Nov. 8, 2022 (EP) 22206022.0

(51) Int. Cl. C09D 7/48; C09D 7/61; C09D 7/63; C09D 7/65; C09D 163/00; H01B 3/30

(52) U.S. Cl. CPC C09D 7/48; C09D 7/61; C09D 7/63; C09D 7/65; C09D 163/00; H01B 3/30

(57) ABSTRACT

Various embodiments of the teachings herein include a formulation for an insulation system and/or an insulating coating, in the form of casting material, powder coating material and/or solvent-containing wet coating material. An example includes: a component A including a liquid or solid base resin in uncrosslinked form with a curing agent and/or accelerant for curing; and a component B comprising a polymeric filler solid at room temperature under standard conditions and having a relative temperature index higher than 160 °C. Component A is present in the range from 0% to 99% by mass and component B is present in the range from 1% to 100% by mass, based on 100% of the solvent-free formulation.

### CROSS-REFERENCE TO RELATED APPLICATIONS

This application is a U.S. National Stage Application of International Application No. PCT/EP2023/078988 filed Oct. 18, 2023, which designates the United States of America, and claims priority to EP Application Serial No. 22206022.0 filed Nov. 8, 2022 and EP Application Serial No. 22203336.7 filed Oct. 24, 2022, the contents of which are hereby incorporated by reference in their entirety.

### TECHNICAL FIELD

The invention generally relates to insulation. Various embodiments of the teachings herein include formulations for high-temperature insulation at maximum operating temperatures of up to 200 °C and higher.

### BACKGROUND

Electric machines for drive systems in general are equipped with a stator, such as in the case of medium- and high-voltage range motors and generators, and comprise electrical conductors, main insulation, conductor insulation, such as wire insulation with partial conductor insulation, and a laminated stator core. The purpose of main insulation is to electrically insulate the phases from one another, from the grounded laminated stator core and from the environment.

Conductor insulation insulates the conductors of the coil from one another. Electric machines are generally operated at highest possible current densities. Traction motors are operated at high temperatures, for example the thermal class of polymer-based plastics of up to 220 °C. The polymeric plastics that are therefore suitable for this purpose are limited to a few polymer types.

On the other hand, a wound insulation system comprises not only surface insulation materials and/or insulation tapes, but also impregnation resin. The surface insulation materials—which form for example the slot liner and/or the insulation tapes—have been hitherto substantially based on m-aramid and/or polyimide in addition to mica and glass owing to a wide variety of requirements. Thermosets with polyesterimide and/or silicone are usually used as impregnation resin in traction motors because of the high thermal class owing to the low processing temperature. Epoxides are usually used in industrial high-voltage motors.

In the case of insulation systems with mica tapes, the paper is bonded to a woven glass support and/or a PET and/or PI film and cut into narrow rolls which then form the insulation tapes and are wound, for example around the conductor or the coil.

In the case of conductor insulations that have been extruded and/or in the case of strip-like conductor insulations that have been spun—less so in the case of solvent-containing wire enamels—it is conventional to use PEEK, PI, PAI, PPS, PEI, polyesterimide (thermoset) and similar synthetic resins. In particular, thermoset wire enamels optimized with respect to partial discharge resistance are commercially available for conductor insulation.

“Hairpin technology” is a winding technology for stators in electric motors and generators that forms a subgroup of wave windings. It is used particularly in traction motors for electric vehicles. In contrast to form-wound winding technology, wave winding technology is based on wire windings which are inserted individually, and not combined as coils, into the stator slots of the laminated core. These plug-in coils, which are called hairpins, wavy hair pins (“continuous hairpin”) and/or I-pins, are enameled and/or extruded flat copper wires bent into the shape of a wave, U or I.

I-pins are, for example, flat copper wires shaped as a straight line, and in the case of the “continuous hairpin” wave winding concept, so-called winding mats are produced and then inserted into the laminated core from the inside. Compared to U-pin and I-pin technology, this has a distinctly lower complexity in the method of joining the individual pins.

The construction of a hairpin stator differs in relation to conventional stators only in the nature of the winding system—the other components of the stator remain substantially unchanged. The windings in the form of an insulated winding wire are realized by plug-in coils in a hairpin stator.

Novel and more cost-effective methods are being tested in hairpin technology, which represents an advanced technology for stators in electric machines. For instance, the flat copper wire having typical hairpin geometry is introduced into the slots of the laminated core in a forming-based assembly method. However, it is essential here to insulate the soldered or welded connection points of the individual hairpins from one another with a coating, since they are not protected by the conductor insulation. However, the thermal resistance of the enamels currently used is limited to thermal class 180 (H).

Here, the finished insulation system is produced by preferably additionally fixing the winding, the wire and/or the hairpin in the slot by casting, impregnation, trickling, dipping and/or injection molding with a synthetic resin. Alternatively, a partial conductor insulated by wire extrusion may be fixed in the slot by injection molding.

### SUMMARY

There continues to be a need for an improved technology for a formulation for producing an insulation system and/or an insulating coating, in particular also suitable for the abovementioned applications—including for use in plug-in coil technology and/or wave winding technology—for example usable e.g. in traction motors for rail vehicles, automobiles, trucks, and/or for insulating coating of, for example, terminal boxes, additively manufactured conductors and/or coils, and busbars or terminal bars. Teachings of the present disclosure include formulations for an insulating coating and/or an insulation system for a rotating electric machine, in particular for use at maximum operating temperatures of higher than 170 °C, in particular of 200 °C or above, preferably even a maximum of 220 °C or above, which is also suitable for use in plug-in coils and/or wave winding technology.

For example, some embodiments include a formulation for an insulation system and/or an insulating coating, in the form of casting material, powder coating material and/or solvent-containing wet coating material, comprising at least a component B, wherein a component A, a liquid or solid base resin in uncrosslinked form with a curing agent and/or accelerant necessary for curing, is also present and component B is in the form of PFT, i.e., in the form of a polymeric filler which is solid at room temperature under standard conditions and has a high relative temperature index, in particular higher than 160 °C, wherein component A is present in the range from 0% to 99% by mass and component B is present in the range from 18 to 100% by mass, based on 100% of the solvent-free formulation.

In some embodiments, the base resin comprises one or more compounds selected from the group consisting of epoxy resin, polyurethane resin, polyisocyanate resin, polyimide resin, polyesterimide resin and/or polyester resin, alone or in any desired mixtures, blends and/or copolymers.

In some embodiments, the curing agent comprises a compound which is an anhydride-based compound, imidazole-based compound and/or dicyanamide-based compound and also any desired derivatives and/or mixtures of these compounds.

In some embodiments, the component A comprises an accelerant.

In some embodiments, the formulation includes further fillers such as fused silica, quartz flour and/or siloxane, alone or in any desired mixtures and combinations.

In some embodiments, the formulation as wet coating material, is present in a solvent such as acetone, isopropanol, ethyl ester, methyl ethyl ketone, butyl acetate in any desired mixtures and/or combinations.

In some embodiments, the component B, includes PFTs having grain sizes from 1 nm to 3 mm.

In some embodiments, the component B, includes PFTs having grain sizes from 0.1 μm to 1000 μm.

In some embodiments, the component B, includes at least two different particle fractions of PFTs having grain sizes from 1 nm to 3 mm.

In some embodiments, the component B comprises PFTs made of high-performance plastic such as
thermoplastic polyimides (TPI)—see also structural formulae I to III,
polyetherimide (PEI),
polybenzimidazole (PBI),
polysiloxane,
polyamideimide (PAI),
polyetherketones, for example
polyetheretherketone (PEEK),
polyetherketoneketone (PEKK),
polyetherketoneetherketoneketone (PEKEKK),
polyetherketone (PEK),
polymeric sulfur compounds, for example
polysulfone (PSU),
polyphenylene sulfide (PPS),
polyethersulfone (PES),
polyphenylene sulfone (PPSU),
in each case present in the particle alone or in any desired mixtures, blends and/or copolymers.

In some embodiments, the component B comprises different PFT particle fractions, each containing different high-performance plastics.

In some embodiments, the component B comprises multiple different particle fractions with PFTs differing in the degree of crystallinity, i.e., PFTs in amorphous form, semicrystalline form and/or crystalline form.

In some embodiments, the component B comprises at least one fiber-reinforced PFT particle fraction.

As another example, some embodiments include a molded body obtainable by curing of a formulation as described herein, the molded body forming an insulation system or parts of an insulation system and/or an electrically insulating coating or parts of an electrically insulating coating.

Some embodiments include the use of a formulation as described herein for producing an insulation system and/or insulating coating by casting, powder coating, fluidized bed coating, wet coating and/or conductor insulation.

### DETAILED DESCRIPTION

Formulations incorporating teachings of the present disclosure may provide a molded body obtainable therefrom by curing, serving as an insulation system, as an insulating coating of electrical conductors and/or as part of said insulation system/insulating coating. For instance, some embodiments include a molded body which is at least part of an insulation system for an electric machine, in particular a rotating electric machine with stator, such as an electric motor and/or a generator, having improved temperature resistance of the polymeric constituents of the insulation system. Similarly, some embodiments include a molded body as part of an insulating coating or forming an entire insulating coating, in particular the insulating coating of—for example—an electrical conductor produced by additive manufacturing, of busbars, of terminal bars and/or the insulating coating of terminal boxes.

Some embodiments include a formulation for an insulation system and/or an insulating coating, in the form of casting material, powder coating material and/or solvent-containing wet coating material, comprising at least a component B, wherein a component A, a liquid or solid base resin in uncrosslinked form with a curing agent and/or accelerant necessary for curing, and component B is in the form of PFT, i.e., in the form of a polymeric filler which is solid at room temperature under standard conditions and has a high relative temperature index, in particular higher than 160 °C, wherein component A is present in the range from 0% to 99% by mass and component B is present in the range from 1% to 100% by mass, based on 100% of the solvent-free formulation.

In addition, some embodiments include a molded body obtainable by curing of the above-described formulation, the molded body forming an insulation system or parts of an insulation system and/or an electrically insulating coating or parts of an electrically insulating coating.

Some embodiments include the use of a formulation, as described above, for producing an insulation system, an insulating coating and/or a conductor insulation by powder coating, fluidized bed coating, wet coating and/or casting.

What is meant by “relative temperature index” herein is the relative temperature index “TI” according to IEC 60216 or DIN EN 60216. This corresponds to the numerical value of the temperature in °C that is derived from the thermal endurance relationship for a period of 20 000 hours at 5% loss of mass.

A formulation as described herein, when cured, forms an insulation system in the form of a conductor insulation and/or parts of a conductor insulation. Nonlimiting examples of the processing of the formulation include carrying out powder coating, casting, fluidized bed coating and/or wet coating to coat conductors, parts of conductors and/or associated housings. The molded body may be cured by heat and/or by radiation, in particular UV curing.

A molded body from the formulation can then—for example—partly or completely form the insulation of one or more individual bars, of the winding head and/or of the switching region of a winding head and/or even the insulation of an entire wire winding. Furthermore, it can act as partial conductor insulation and/or as individual bar insulation of a plug-in coil and of any other conductor element in wave winding technology and/or as an insulating coating of an additively manufactured conductor element. Lastly, the formulation can completely or partly form an insulating coating of busbars and/or terminal bars and/or terminal boxes.

Conductor insulation is, for example, the electrical insulation of the individual conductor windings of a coil from one another and/or of the conductors of a wire winding and/or from the environment and/or from ground, for example the electric machine.

Fluidized bed coating is to be understood to mean the coating of a conductor in a fluidized bed filled with a powder coating formulation. This uses in particular a powder composed of compounds which are solid under standard conditions, i.e., the base resin will preferably also be in solid form in addition to the particulate thermoplastics that are in solid form anyway.

Powder coating, in particular electrostatic powder coating, is carried out, for example, by spraying and/or in a fluidized bed method. This uses a powder composed of solids, i.e., the base resin is also present as a solid in addition to the particulate thermoplastics that are in solid form anyway.

Wet coating is carried out, for example, by coating, painting, dipping, spraying, spin coating and/or dipping methods. The formulation, dissolved in a solvent, is applied to the conductor, the solvent is then removed—at least to some extent—and the formulation is cured. In addition, the base resin may be present as a solid and/or as a liquid.

Casting is carried out with a liquid formulation without any solvent, with the base resin, unlike the formulation used as powder coating material, being present as a liquid under standard conditions.

“Standard conditions”—a relevant aspect particularly with respect to processing conditions and storage stability—refers to a room temperature of 25 °C, ambient air and standard pressure.

In a formulation for a casting material, in the form of a fluidized bed powder, in the form of a powder coating material and/or for a wet coating material for producing an electrical insulation system and/or an insulating coating, the incorporation of plastics filler particles present in solid and polymeric form and having a high relative temperature index—polymeric filler having a high relative temperature index or “PFT”—has advantages with respect to thermomechanical stability and particularly with respect to temperature stability. This may provide increased power densities of the electrical conductors, since the increase in power density always entails an increase in operating temperatures.

The PFTs described herein have a high temperature index “TI” that is in particular above 160 °C, above 170 °C, above 180 °C or above 190 °C. The PFTs used are those with a high glass transition temperature. In particular, this is the case for thermoplastic, elastomeric and/or thermoset particles having a glass transition temperature of greater than or equal to 130 °C, greater than or equal to 150 °C, in a mixture with component A, comprising a base resin still in uncrosslinked form, curing agent and/or accelerant; here, the presence of PFTs achieves clear mechanical and/or thermomechanical advantages and/or a distinct increase in the temperature resistance of the resultant insulation system and/or insulating coating.

The thermoplastic, elastomeric and/or thermoset PFTs of the component B are identical or different, for example with respect to material, surface treatment, surface coating, crystallinity, amorphousness, grain size, particle shape and/or fiber reinforcement. The PFTs may be in deagglomerated form.

Component B contains the PFTs and its mass in the dry formulation, based on 100% by mass of solvent-free formulation, is in the range from 1% to 99% by mass, in particular from 10% to 60% or from 20% to 50%, or in the range from 20% to 30% by mass, based on 100% by mass of solvent-free formulation.

The “base resin” may comprise a curing agent, accelerant, additives, auxiliary substances, further fillers, then forms the remainder up to 100% by mass of the solvent-free formulation.

In some embodiments, component A is the base resin in the form of a thermoset resin which has not yet been crosslinked and which comprises one or more compounds selected from the group consisting of epoxy resin, polyurethane resin, polyisocyanate resin, polyimide resin, polyesterimide resin and/or polyester resin in any desired mixtures, blends and/or copolymers. For example, the uncrosslinked thermoset synthetic resin in the formulation comprises compounds such as bisphenol A diglydidyl ether, bisphenol F diglycidyl ether, novolak, aliphatic epoxy resin and/or aromatic epoxy resin. In the case of solvent-free use as casting material and/or as solvent-containing wet coating material, the base resin may also be in liquid form under standard conditions, and in the case of use as powder coating material, it is a powder, i.e., a solid.

In some embodiments, the component A, i.e., in a stoichiometrically suitable amount and of appropriate chemistry in relation to the base resin, is a curing agent, for example an anhydride-based compound, imidazole-based compound, bisphenol-based compound and/or dicyanamide-based compound.

For initiation of curing after the formulation has been applied to—for example after the powder coating material has been sprayed onto—the body to be insulated, for example a plug-in coil in the case of hairpin technology, the component A may also contain an accelerant in a small amount, for example in the range from 0.3% to 2% by mass. Accelerants for this application are known to a person skilled in the art; examples of accelerants that may be used include urea such as dimethylurea, 1,1-dimethyl-3-phenylurea, toluene bis-1,1-dimethylurea, 3-(3-trifluoromethylphenyl)-1,1-dimethylurea, 2-phenylimidazole and/or benzyldimethylamine.

A powder coating material may also be used in individual bar insulation in hairpin technology, wave winding technology and/or plug-in coil technology. Individual bars may be coated or sprayed—for example automatically—with powder coating material, for example in a conveyor belt method, before being subjected to thermal and/or UV curing.

As wet coating material, the formulation is in dissolved form in a solvent. Examples of suitable solvents are: acetone, isopropanol, ethyl ester, methyl ethyl ketone, butyl acetate in any desired mixtures and/or combinations. Furthermore, the wet coating material may possibly contain a common thixotropic agent as an admixture.

In some embodiments, the PFTs of the component B range from 1 nm to 3 mm, or from 0.1 μm to 1000 μm, in grain size. The PFTs in component B may be identical or different with respect to their grain size and particle shape. In particular, different thermosets and/or thermoplastics and/or different grain sizes of a plastic may also be present as a mixture.

It has been found to be appropriate to incorporate at least one particle fraction having an average grain size d₅₀ in the range from 500 nm to 300 μm, in particular from 1 μm to 200 μm and for example in the range from 2 to 100 μm, for example between 2.5 μm and 10 μm.

In some embodiments, the component B is a multimodal mixture of particles of different grain sizes, such that coarser and finer fractions complement each other, particularly with respect to the mechanical properties when processing the formulation. For instance, it is known that smaller particle fractions can act as ball bearings for larger particles with respect to the flowability of the formulation.

The PFTs of the component B may—as needed—be present in the formulation in amorphous form, in semicrystalline form, with crystalline fractions, and in any desired mixtures of the aforementioned allotropes. Fractions or all PFTs of the component B may also be in reinforced form, in particular fiber-reinforced form. All types of non-electrically conductive fillers may be incorporated, and so the component B may contain, for example, aramid fiber-reinforced or glass fiber-reinforced thermoplastic particles.

The PFTs comprise, for example, solid polymeric filler particles made of materials such as high-performance plastic—in some cases, having relative temperature index greater than 190 °C and preferably greater than 200 °C—and comprise for example:
thermoplastic polyimides (TPI)—see also structural formulae I to III,
polyetherimide (PEI),
polybenzimidazole (PBI),
thermoplastic silicone, in the form of polymeric filler particles
that are in solid form after appropriate Frost treatment,
polyamideimide (PAI),
polyetherketones, for example
polyetheretherketone (PEEK),
polyetherketoneketone (PEKK),
polyetherketoneetherketoneketone (PEKEKK),
polyetherketone (PEK),
polymeric sulfur compounds, for example
polysulfone (PSU),
polyphenylene sulfide (PPS),
polyethersulfone (PES),
polyphenylene sulfone (PPSU),
in each case present in the particle alone or in any desired mixtures, blends and/or copolymers.

In some embodiments, the component B comprise PFTs made of a thermoplastic polyimide (TPI) corresponding to structural formula I:
Structural formula I

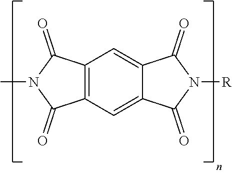

and/or structural formula II
Structural formula II

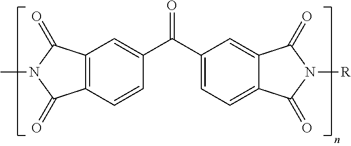

where
   applicable to the two structural formulae I and II—
n=1 to 10 000
R is identical or nonidentical and is any desired aliphatic and/or aromatic organic, hydrocarbon-based, optionally heteroatom-substituted, organic radical having any desired functional groups.

Therefore, it is possible that R=alkyl, aryl, O,S-alkyl, O,S-aryl, N,P-aryl, N,P-alkyl having any desired functional groups, such as acid groups, ester groups, ether groups, etc.

In some embodiments, the component B comprises, for example, PFTs made of a TPI comprising—at least as a constituent—structural formula III:
Structural formula III

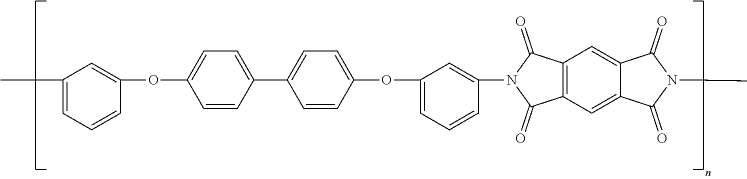

Again with n in the range from 1 to 10 000.

A thermoplastic compound comprising an element having structure III may, however, also be present as a constituent of any desired copolymers and/or blends as PFT in the component B. Particles made of thermoplastic high-performance plastic having the abovementioned structural formulae I to III may have, for example, glass transition temperature Tgs of up to 350 °C.

Thermoplastic high-performance plastics used for example as PFT may be in pure form but also in any desired blends and/or copolymers in PFTs of the component B.

In some embodiments, the component B comprises, for example, different particle fractions, each containing different high-performance plastics.

PFTs of the component B may possibly be in coated or uncoated form.

PFTs of the component B are, for example, in surface-treated form, one option for surface treatment being chemical and/or physical functionalization of the surface with respect to better binding to the thermoset resin.

In some embodiments, the component B comprises at least one particle fraction of PFTs having fiber-reinforced particles. In addition to the component B, the formulation may contain further fillers such as quartz flour, fused silica, mica, siloxane, alone or in any desired mixtures.

In some embodiments, the formulation may additionally contain the customary additives for a casting material, powder coating material or wet coating material, such as flow agents, degassers and any other desired commonly known additives for electrical insulation systems.

The teachings herein are more particularly elucidated below with reference to a few examples.

### Example 1

Base resin, bisphenol A: 46.5%
Curing agent, dicyandiamide: 0.5%
Accelerant, toluene bis-1,1-dimethylurea: 0.5%
Filler, quartz flour: 20%
Filler 2, siloxane/polyimide copolymer: 10%
Polymeric filler having a high temperature index (PFT), polyimide,
structural formula II: 20%
Additive, flow agent: 1%
Additive, degasser: 1.5%

### Example 2

Base resin, bisphenol A: 55.5%
Curing agent, dicyandiamide: 1%
Accelerant, toluene bis-1,1-dimethylurea: 1%
PFT, polyimide, structural formula II: 40%
Additive, anticratering and flow agent: 1.5%
Additive, degasser: 1%

The addition of the PFTs in the component B followed by measurement of the temperature index resulted in measurement of an increase from 154 °C for the pure DGEBA/DICY formulation to 183 °C for the formulation admixed with 30% component B in the form of PFTs based on thermoplastic polyimide.

The presently disclosure provides insulation formulations for insulation systems and for insulating coatings that shows a drastic improvement over the prior art, in particular the base resins without PFTs, because they simultaneously show:
outstanding resistance to environmental influences,
outstanding storage stability—3 months or longer—at room temperature,
improved thermomechanical behavior of the insulation systems and insulating coatings produced therefrom, and
good processibility as casting material, powder coating material or wet coating material.

The teachings herein generally relate to the field of insulation and relates in particular to a formulation for high-temperature insulation at operating temperatures of 200 °C or higher. The insulation serves as insulation of electrical conductors. For instance, the invention relates to an insulation system for an electric machine, in particular a rotating electric machine with stator, such as an electric motor and/or a generator, having improved temperature resistance of the polymeric constituents of the insulation system and/or to an insulating coating for additively manufactured conductors or parts thereof, busbars, terminal bars and/or terminal boxes.

Some embodiments include a formulation for a powder coating material, for a powder for a fluidized bed, for a casting resin and/or a formulation for a wet coating material that comprises, as component B, PFTs, i.e., high-performance plastics in fully cured, polymeric and—even in the case of thermoplastics—solid form, it having been found that PFTs can increase the thermal resistance of the resultant material considerably while also introducing improved thermomechanical properties into an insulation system produced therefrom and/or an insulating coating produced therefrom. The invention is used for producing insulation systems for rotating electric machines. Other fields of use of the formulation according to the invention are, for example, insulating coating of additively manufactured conductors, busbars and/or terminal bars and the coating of terminal boxes.

What is claimed is:

1. A formulation for an insulation system and/or an insulating coating, in the form of casting material, powder coating material and/or solvent-containing wet coating material, comprising:
a component A including a liquid or solid base resin in uncrosslinked form with a curing agent and/or accelerant for curing;
and
a component B comprising a polymeric filler solid at room temperature under standard conditions and having a relative temperature index higher than 160 °C;
wherein
component A is present in the range from 0% to 99% by mass and component B is present in the range from 1% to 100% by mass, based on 100% of the solvent-free formulation.

2. The formulation as claimed in claim 1, wherein the base resin comprises one or more compounds selected from the group consisting of: epoxy resin, polyurethane resin, polyisocyanate resin, polyimide resin, polyesterimide resin, and polyester resin.

3. The formulation as claimed in claim 1, wherein the curing agent comprises an anhydride-based compound, an imidazole-based compound, and/or a dicyanamide-based compound.

4. The formulation as claimed in claim 1, wherein the component A comprises an accelerant.

5. The formulation as claimed in claim 1, further comprising additional fillers.

6. The formulation as claimed in claim 1, further comprising a solvent.

7. The formulation as claimed in any claim 1, wherein the PFTs have grain sizes from 1 nm to 3 mm.

8. The formulation as claimed in claim 1, wherein the PFTs have grain sizes from 0.1 μm to 1000 μm.

9. The formulation as claimed in any claim 1, wherein the component B has at least two different particle fractions of PFTs with grain sizes from 1 nm to 3 mm.

10. The formulation as claimed in claim 1, wherein the PETS comprises at least one plastic selected from the group consisting of:
thermoplastic polyimides (TPI)—see also structural formulae I to III,
polyetherimide (PEI),
polybenzimidazole (PBI),
polysiloxane,
polyamideimide (PAI),
polyetherketones, for example
polyetheretherketone (PEEK),
polyetherketoneketone (PEKK),
polyetherketoneetherketoneketone (PEKEKK),
polyetherketone (PEK), p
polysulfone (PSU),
polyphenylene sulfide (PPS),
polyethersulfone (PES), and
polyphenylene sulfone (PPSU).

11. The formulation as claimed in claim 1, wherein the component B comprises multiple PFT particle fractions, each containing different high-performance plastics.

12. The formulation as claimed in claim 1, wherein the component B comprises multiple different particle fractions with PFTs differing in the degree of crystallinity.

13. The formulation as claimed in claim 1, wherein the component B comprises at least one fiber-reinforced PFT particle fraction.

14-15. (canceled)
